(19) United States
(12) Patent Application Publication
(10) Pub. No.: US 2020/0151569 A1
(43) Pub. Date: May 14, 2020

(54) WARPING SEQUENCE DATA FOR LEARNING IN NEURAL NETWORKS

(71) Applicant: INTERNATIONAL BUSINESS MACHINES CORPORATION, Armonk, NY (US)

(72) Inventors: Jun Chi Yan, Shanghai (CN); Jun Zhu, Shanghai (CN); Guo Qiang Hu, Shanghai (CN); Jing Chang Huang, Shanghai (CN); Peng Ji, Nanjing (CN); Zhi Hu Wang, Beijing (CN)

(21) Appl. No.: 16/184,180

(22) Filed: Nov. 8, 2018

(51) Int. Cl. G06N 3/08; G06N 3/04

(52) U.S. Cl. CPC G06N 3/084; G06N 3/04

(57) ABSTRACT

Methods and systems for classification of sequence data include warping training sequence data according to a warping pattern. A neural network is trained using the warped training sequence data. Input sequence data is warped according to the warping pattern. The warped input sequence data is classified using the trained neural network.

### BACKGROUND

### Technical Field

The present invention generally relates to learning in neural networks and, more particularly, to the modification of linear data sequences to be suitable for two-dimensional neural network inputs.

### Description of the Related Art

An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained in-use, with learning that involves adjustments to weights that exist between the neurons. An ANN is configured for a specific application, such as pattern recognition or data classification, through such a learning process.

Referring now to FIG. 1, a generalized diagram of a neural network is shown. ANNs demonstrate an ability to derive meaning from complicated or imprecise data and can be used to extract patterns and detect trends that are too complex to be detected by humans or other computer-based systems. The structure of a neural network is known generally to have input neurons 102 that provide information to one or more “hidden” neurons 104. Connections 108 between the input neurons 102 and hidden neurons 104 are weighted and these weighted inputs are then processed by the hidden neurons 104 according to some function in the hidden neurons 104, with weighted connections 108 between the layers. There may be any number of layers of hidden neurons 104, and as well as neurons that perform different functions. There exist different neural network structures as well, such as convolutional neural network, maxout network, etc. Finally, a set of output neurons 106 accepts and processes weighted input from the last set of hidden neurons 104.

This represents a “feed-forward” computation, where information propagates from input neurons 102 to the output neurons 106. Upon completion of a feed-forward computation, the output is compared to a desired output available from training data. The error relative to the training data is then processed in “feed-back” computation, where the hidden neurons 104 and input neurons 102 receive information regarding the error propagating backward from the output neurons 106. Once the backward error propagation has been completed, weight updates are performed, with the weighted connections 108 being updated to account for the received error. This represents just one variety of ANN.

Convolutional neural networks (CNNs) are a particular variety of ANN that is commonly used for deep learning in vision, speech, and natural language tasks. Recurrent neural networks (RNNs) are a form of ANN that is commonly used to learn sequence data. However, RNNs are more difficult to tune than CNNs and provide fewer options for customizing the network architecture when compared to CNNs, which include max pooling layers and convolutional filters.

### SUMMARY

A method for classification of sequence data includes warping training sequence data according to a warping pattern. A neural network is trained using the warped training sequence data. Input sequence data is warped according to the warping pattern. The warped input sequence data is classified using the trained neural network.

A system for classification of sequence data includes a warping module having a processor configured to warp training sequence data and input sequence data according to a warping pattern. A training module is configured to train a neural network using the warped training sequence data. A classification module is configured to classify the warped input sequence data using the trained neural network.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram of a prior art neural network configuration;

FIG. 2 is a diagram of warping a one-dimensional sequence of data into a two-dimensional matrix that is suitable for use with a convolutional neural network (CNN) to capture long-range dependencies within the sequence of data in accordance with an embodiment of the present invention;

FIG. 3 is a diagram of alternative warping patterns for warping a one-dimensional sequence of data into a two-dimensional matrix in accordance with an embodiment of the present invention;

FIG. 4 is a block/flow diagram of a method for classifying sequence data by warping the sequence data into a higher-dimensional input to a CNN in accordance with an embodiment of the present invention;

FIG. 5 is a diagram of the structure of a neural network in accordance with an embodiment of the present invention;

FIG. 6 is a block diagram of a sequence classification system that classifies sequence data by warping the sequence data into a higher-dimensional input to a CNN in accordance with an embodiment of the present invention; and

FIG. 7 is a block diagram of a processing system in accordance with an embodiment of the present invention.

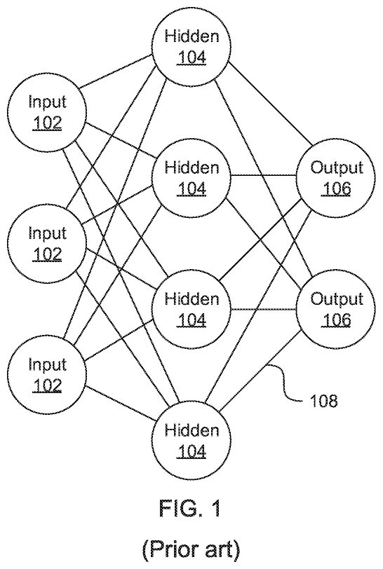

### DETAILED DESCRIPTION

Embodiments of the present invention modify input data sequences to make them suitable for use as inputs to convolutional neural networks (CNNs). CNNs are well-suited to two-dimensional inputs, such as image data, but are not well-explored as tools for processing sequential data, such as text or time-series information. The present embodiments therefore map the sequential data onto a two-dimensional structure, such as a matrix or array, that preserves locality. The resulting warped data is usable with CNN filters and captures long-term dependency between elements in the sequence through the CNN's local convolution layers.

It should be understood that recurrent neural networks (RNNs) and CNNs that operate on only single-dimensional input are ill-suited to capturing long-range dependencies in long sequences of input data. However, by warping the sequence data into two-dimensional or higher-dimensional inputs, even a local filter in a CNN can access input data spanning over a long time scale. This makes the resulting model more suited to capturing long-range data dependencies. In some embodiments, multiple different warping patterns can be used by, e.g., merging or concatenating the different warped representations of a sequence into a single input to the CNN. The CNN filters are then able to process the data as a combination of diverse sequence time windows. The result is a CNN that has improved predictive ability when handling input sequences that have long-term data dependencies, resulting in more accurate models.

Exemplary applications of the improved classification of sequence data provided herein include, for example, natural language processing tasks, analysis of time-series information such as in security log analysis and performance/productivity analysis, and any other system where the input represents a long sequence of data with complex or hidden dependencies. The present embodiments thereby provide substantial improvements to a variety of technical fields.

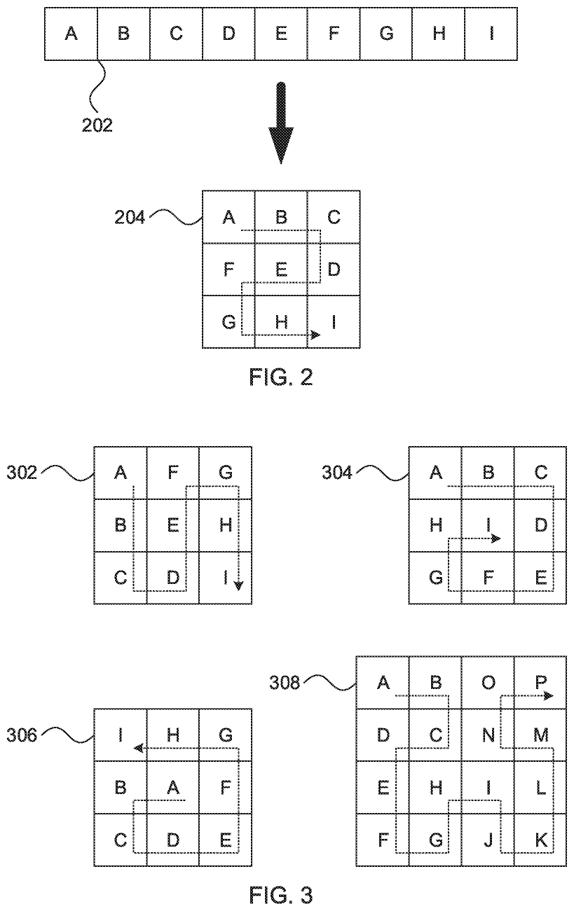

Referring now to FIG. 2, an example of sequence warping is shown. An input data sequence 202 is shown, being broken up into individual data blocks. The sequence is then warped into a two-dimensional matrix 204, where the adjacency of data blocks from the original sequence is maintained. It should be understood that there are many different warping patterns that are contemplated. In simple embodiments, such as the one shown, the sequence data can fill in the matrix one row or column at a time, with each subsequent row or column being filled in a direction opposite to that used for the previous row or column.

In other embodiments, the warping pattern can warp the sequence data to three or more dimensions. This can be accomplished by using one of the above warping patterns and an appropriate sampling. For example, in a three-dimensional warping pattern, multiple such matrices can be formed. If the warping pattern generates a 3×3×3 array, then every third element, starting with the first element, can be sampled to form a single matrix in the 3×3×3 array. The next matrix can be formed by sampling every third element, starting with the second element, and the last matrix can be formed by sampling every third element, starting with the third element. Following the above example, the input sequence would be broken into three sub-sequences, ADG . . . , BEH . . . , and CFI . . . , with each respective sub-sequence being mapped according to a same warping pattern.

It should be understood that the respective dimensions of the warping pattern need not be equal. For example, although only square matrices are depicted herein, the warping pattern can also map the sequences onto rectangular matrices with differently sized dimensions. The dimensions of the matrix will be determined by the structure of the CNN and the data format needed.

Referring now to FIG. 3, a set of other warping embodiments is shown. In warping 302, the matrix is filled column-by-column. In warping 304, the matrix is filled in a spiral fashion, working inward from a corner element. In warping 306, another spiral embodiment is shown with the spiral beginning at a middle element and working outward to a corner element. In warping 308, a Hilbert curve is used to map the input sequence onto the matrix. The Hilbert curve is particularly advantageous for longer sequences of data, as it imposes a fractal arrangement on the data that maintains relative nearness of elements.

It should be understood that the warping embodiments introduced herein are provided solely for the purpose of illustration and should not be interpreted as being limiting. Any warping from one-dimensional sequence data to a two-dimensional matrix can be used, particularly those that maintain the adjacency of elements in the original sequence.

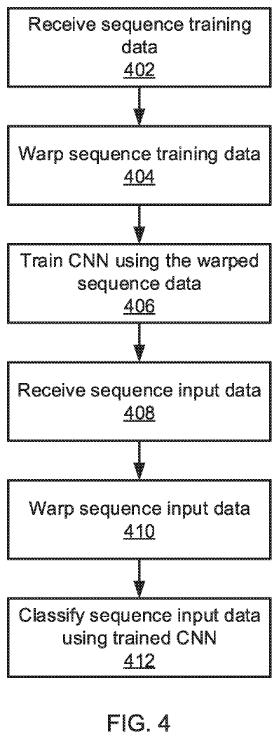

Referring now to FIG. 4, a method for training and using a neural network is shown. Block 402 receives a set of sequence training data. The training data may include, for example, sequences with predetermined, known-correct classifications. A first part of the training data can be used for the actual training of the neural network, while a second part of the training data can be used to verify that the trained neural network produces accurate classifications. Due to the flexibility of neural networks, any variety of sequence data can be used. The neural network classifier that is trained by the present embodiments will be able to perform classification regardless of what the underlying data represents.

Block 404 then warps the sequence data. For example, the sequence data can be mapped onto a two-dimensional matrix, with values that are adjacent in the original training data also being adjacent in the warped data. As noted above, any appropriate warping pattern can be used to map the sequence data to the two-dimensional matrix. Block 406 then uses the warped training data to train a CNN and produce a classifier for the sequence data.

Once the classifier has been trained, block 408 receives input sequence data that represents unclassified sequences. Block 410 warps the input sequence data according to the same warping pattern as is used in block 404 so that the structure of the sequence data is maintained. Block 412 then classifies the warped input sequence data using the trained CNN classifier to generate a label for each input sequence.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

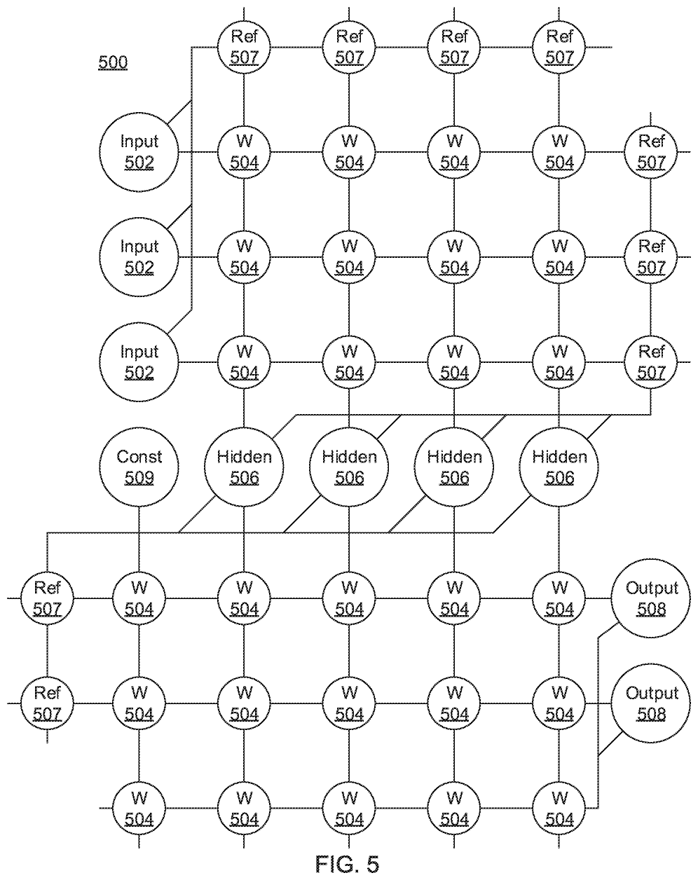

Referring now to FIG. 5, a general artificial neural network (ANN) architecture 500 is shown. It should be understood that the present architecture is purely exemplary and that other architectures or types of neural network may be used instead. In particular, a CNN may have many different layers, each with different properties, according to the needs of the particular application. It should also be understood that, although the present embodiments are described in terms of a hardware embodiment for the purpose of providing an intuitive understanding of how neural network calculations can be performed, it should be understood that alternative embodiments can use a software implementation of the neural network.

During feed-forward operation, a set of input neurons 502 each provide an input voltage in parallel to a respective row of weights 504. Although a one-dimensional input layer is shown, it should be understood that two or more dimensions can be used instead, with correspondingly greater dimensionalities in the weight arrays and subsequent neuron layers, as appropriate. The weights 504 each have a settable resistance value, such that a current output flows from the weight 504 to a respective hidden neuron 506 to represent the weighted input. The current output by a given weight is determined as l=V/r, where V is the input voltage from the input neuron 502 and r is the set resistance of the weight 504. The current from each weight adds column-wise and flows to a hidden neuron 506. A set of reference weights 507 have a fixed resistance and combine their outputs into a reference current that is provided to each of the hidden neurons 506. Because conductance values can only be positive numbers, some reference conductance is needed to encode both positive and negative values in the matrix. The currents produced by the weights 504 are continuously valued and positive, and therefore the reference weights 507 are used to provide a reference current, above which currents are considered to have positive values and below which currents are considered to have negative values.

As an alternative to using the reference weights 507, another embodiment may use separate arrays of weights 504 to capture negative values. Each approach has advantages and disadvantages. Using the reference weights 507 is more efficient in chip area, but reference values need to be matched closely to one another. In contrast, the use of a separate array for negative values does not involve close matching as each value has a pair of weights to compare against. However, the negative weight matrix approach uses roughly twice the chip area as compared to the single reference weight column. In addition, the reference weight column generates a current that needs to be copied to each neuron for comparison, whereas a negative matrix array provides a reference value directly for each neuron. In the negative array embodiment, the weights 504 of both positive and negative arrays are updated, but this also increases signal-to-noise ratio as each weight value is a difference of two conductance values. The two embodiments provide identical functionality in encoding a negative value and those having ordinary skill in the art will be able to choose a suitable embodiment for the application at hand.

The hidden neurons 506 use the currents from the array of weights 504 and the reference weights 507 to perform some calculation. The hidden neurons 506 then output a voltage of their own to another array of weights 504. This array performs in the same way, with a column of weights 504 receiving a voltage from their respective hidden neuron 506 to produce a weighted current output that adds row-wise and is provided to the output neuron 508.

It should be understood that any number of these stages may be implemented, by interposing additional layers of arrays and hidden neurons 506. It should also be noted that some neurons may be constant neurons 509, which provide a constant voltage to the array. The constant neurons 509 can be present among the input neurons 502 and/or hidden neurons 506 and are only used during feed-forward operation.

During back propagation, the output neurons 508 provide a voltage back across the array of weights 504. The output layer compares the generated network response to training data and computes an error. The error is applied to the array as a voltage pulse, where the height and/or duration of the pulse is modulated proportional to the error value. In this example, a row of weights 504 receives a voltage from a respective output neuron 508 in parallel and converts that voltage into a current which adds column-wise to provide an input to hidden neurons 506. The hidden neurons 506 combine the weighted feedback signal with a derivative of its feed-forward calculation and stores an error value before outputting a feedback signal voltage to its respective column of weights 504. This back propagation travels through the entire network 500 until all hidden neurons 506 and the input neurons 502 have stored an error value.

During weight updates, the input neurons 502 and hidden neurons 506 apply a first weight update voltage forward and the output neurons 508 and hidden neurons 506 apply a second weight update voltage backward through the network 500. The combinations of these voltages create a state change within each weight 504, causing the weight 504 to take on a new resistance value. In this manner the weights 504 can be trained to adapt the neural network 500 to errors in its processing. It should be noted that the three modes of operation, feed forward, back propagation, and weight update, do not overlap with one another.

In one particular embodiment, the weights 504 may be implemented in software or in hardware, for example using relatively complicated weighting circuitry or using resistive cross point devices. Such resistive devices may have switching characteristics that have a non-linearity that can be used for processing data. The weights 504 may belong to a class of device called a resistive processing unit (RPU), because their non-linear characteristics are used to perform calculations in the neural network 500. The RPU devices may be implemented with resistive random access memory (RRAM), phase change memory (PCM), programmable metallization cell (PMC) memory, or any other device that has non-linear resistive switching characteristics. Such RPU devices may also be considered as memristive systems.

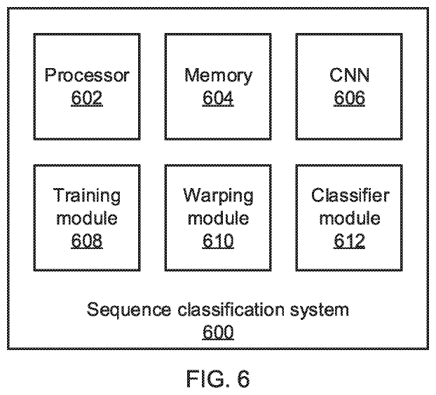

Referring now to FIG. 6, a sequence classification system 600 is shown. The system 600 includes a hardware processor 602 and a memory 604. A convolutional neural network 606 can, as noted above, be implemented in software or that can, alternatively, be implemented in a purely hardware embodiment. The system 600 also includes one or more functional modules that, in some embodiments, are implemented as software that is stored in memory 604 and executed by hardware processor 602. In other embodiments, one or more of the functional modules can be implemented as one or more discrete hardware components in the form of, e.g., application-specific integrated chips or field programmable gate arrays.

A training module 608 trains the CNN 606 according to a set of sequence training data. A warping module 610 is used to convert the sequence training data into a format that the CNN 606 can use, for example mapping the sequences of the training data into two-dimensional matrices according to a warping pattern. A classifier module 612 then uses the trained CNN 606 to classify new input sequences after the new input sequences have been warped with the warping module 610.

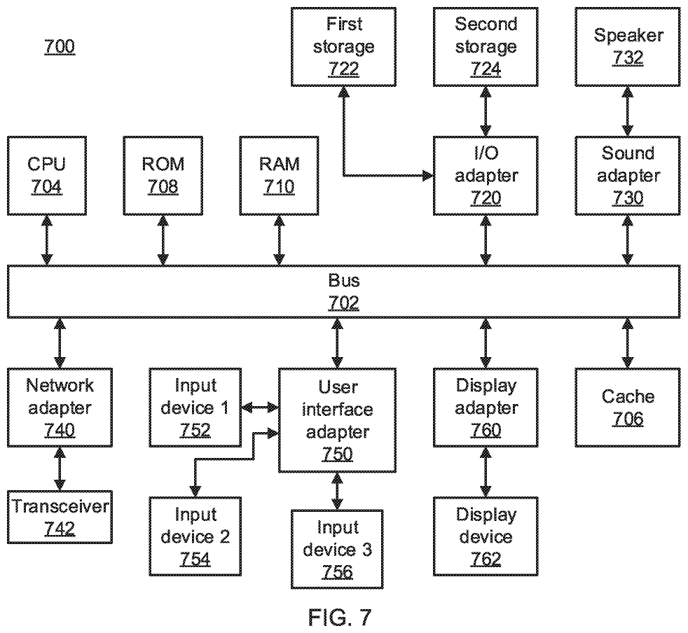

Referring now to FIG. 7, an exemplary processing system 700 is shown which may represent the classification system 600. The processing system 700 includes at least one processor (CPU) 704 operatively coupled to other components via a system bus 702. A cache 706, a Read Only Memory (ROM) 708, a Random Access Memory (RAM) 710, an input/output (I/O) adapter 720, a sound adapter 730, a network adapter 740, a user interface adapter 750, and a display adapter 760, are operatively coupled to the system bus 702.

A first storage device 722 and a second storage device 724 are operatively coupled to system bus 702 by the I/O adapter 720. The storage devices 722 and 724 can be any of a disk storage device (e.g., a magnetic or optical disk storage device), a solid state magnetic device, and so forth. The storage devices 722 and 724 can be the same type of storage device or different types of storage devices.

A speaker 732 is operatively coupled to system bus 702 by the sound adapter 730. A transceiver 742 is operatively coupled to system bus 702 by network adapter 740. A display device 762 is operatively coupled to system bus 702 by display adapter 760.

A first user input device 752, a second user input device 754, and a third user input device 756 are operatively coupled to system bus 702 by user interface adapter 750. The user input devices 752, 754, and 756 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 752, 754, and 756 can be the same type of user input device or different types of user input devices. The user input devices 752, 754, and 756 are used to input and output information to and from system 700.

Of course, the processing system 700 may also include other elements (not shown), as readily contemplated by one of skill in the art, as well as omit certain elements. For example, various other input devices and/or output devices can be included in processing system 700, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 700 are readily contemplated by one of ordinary skill in the art given the teachings of the present principles provided herein.

Having described preferred embodiments of warping sequence data for learning in neural networks (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method for classification of sequence data, comprising:
warping training sequence data according to a warping pattern;
training a neural network using the warped training sequence data;
warping input sequence data according to the warping pattern; and
classifying the warped input sequence data using the trained neural network.

2. The computer-implemented method of claim 1, wherein the warping pattern maps sequence data to a multi-dimensional array.

3. The computer-implemented method of claim 2, wherein the warping pattern warps the sequence data to a two-dimensional matrix in a column-by-column or row-by-row manner.

4. The computer-implemented method of claim 2, wherein the warping pattern warps the sequence data to a two-dimensional matrix in a spiral manner.

5. The computer-implemented method of claim 2, wherein the warping pattern warps the sequence data to a two-dimensional matrix according to a Hilbert curve.

6. The computer-implemented method of claim 2, wherein the warping pattern warps the sequence data to a three-dimensional matrix by sampling sub-sequences of the sequence data and mapping each sub-sequence to a two-dimensional matrix.

7. The computer-implemented method of claim 1, wherein the warping pattern maintains adjacency between data elements from sequence data.

8. The computer-implemented method of claim 1, wherein the neural network is a convolutional neural network that takes two-dimensional data matrices as an input.

9. The computer-implemented method of claim 1, wherein the sequence data comprises data selected from a group consisting of text data and time series data.

10. The computer-implemented method of claim 1, further comprising:
warping the training sequence data and the input sequence data according to at least one additional warping pattern;
combining the training sequence data that is warped according to the warping pattern with the training sequence data that is warped according to the at least one additional warping pattern to form a single training input for the neural network; and
combining the input sequence data that is warped according to the warping pattern with the training sequence data that is warped according to the at least one additional warping pattern to form a single classification input to the trained neural network.

11. A non-transitory computer readable storage medium comprising a computer readable program for classification of sequence data, wherein the computer readable program when executed on a computer causes the computer to perform the steps of:
warping training sequence data according to a warping pattern;
training a neural network using the warped training sequence data;
warping input sequence data according to the warping pattern; and
classifying the warped input sequence data using the trained neural network.

12. A system for classification of sequence data, comprising:
a warping module comprising a processor configured to warp training sequence data and input sequence data according to a warping pattern;
a training module configured to train a neural network using the warped training sequence data; and
a classification module configured to classify the warped input sequence data using the trained neural network.

13. The system of claim 12, wherein the warping pattern maps sequence data to a multi-dimensional array.

14. The system of claim 13, wherein the warping pattern warps the sequence data to a two-dimensional matrix in a column-by-column or row-by-row manner.

15. The system of claim 13, wherein the warping pattern warps the sequence data to a two-dimensional matrix in a spiral manner.

16. The system of claim 13, wherein the warping pattern warps the sequence data to a two-dimensional matrix according to a Hilbert curve.

17. The system of claim 13, wherein the warping module is configured to warps the sequence data to a three-dimensional matrix by sampling sub-sequences of the sequence data, wherein the warping pattern maps each sub-sequence to a two-dimensional matrix.

18. The system of claim 12, wherein the warping pattern maintains adjacency between data elements from sequence data.

19. The system of claim 12, wherein the neural network is a convolutional neural network that takes two-dimensional data matrices as an input.

20. The system of claim 12, wherein the sequence data comprises data selected from a group consisting of text data and time series data.
